(19) United States
(12) Patent Application Publication
(10) Pub. No.: US 2018/0014478 A1
(43) Pub. Date: Jan. 18, 2018

(54) ROOT INTRUSION IMPROVEMENTS IN IRRIGATION TUBES

(71) Applicant: E I DU PONT DE NEMOURS AND COMPANY, Wilmington, DE (US)

(72) Inventors: Ioannis V. Bletsos, Midlothian, VA (US); Robert Rudolph Matheson, JR., Glen Allen, VA (US)

(21) Appl. No.: 15/546,133

(22) PCT Filed: Feb. 1, 2016
(86) PCT No.: PCT/US16/15926

§ 371 Date: Jul. 25, 2017

Related U.S. Application Data
(60) Provisional application No. 62/110,711, filed on Feb. 2, 2015.

(51) Int. Cl. A01G 25/06; D04H 1/58; D04H 1/552; D04H 1/555; D04H 3/14; D04H 3/12

(52) U.S. Cl. CPC A01G 25/06; D04H 3/14; D04H 3/12; D04H 1/552; D04H 1/555; D04H 1/58

(57) ABSTRACT

An aqueous fluid irrigation system for protecting a region of a subsurface irrigation tube from root or microbial mass intrusion, comprising a porous cover covering a subsurface irrigation tube, wherein the cover essentially covers the region of the tube surface, and wherein the cover comprises a non-plexifilamentary material characterized by a peak void volume of less than 35 microns, and any planar region of the non-plexifilamentary material of an area of 500 square microns or less contains a contiguous polymer structure that remains contiguous when exposed to aqueous fluid.

### FIELD OF THE INVENTION

### Background

Plant roots intrude into emitters used in Subsurface Drip Irrigation (SDI) tapes. As a result SDI emitters get deformed and clogged by roots, attached soil particles, or masses of microbial entities (“microbial mass”) and they are eventually destroyed. Consequently, the soil around clogged emitters is not irrigated leading to non-uniform flow along the SDI tape and to an overall poor irrigation performance. This is a serious disadvantage of SDI that costs considerably in repairs and crop yield losses.

Root intrusion problems are mitigated by redesigning the SDI emitter geometry, by adding chemical compounds and herbicides and by irrigation management. Reducing the emitter size has helped, but it has created clogging problems due to dissolved or suspended solids in water. Injection of chlorine, acids and acidic fertilizers prevents and remediates root intrusion by oxidizing the roots but it causes adverse effects to the soil and damage to other system components. Adding herbicides in the irrigation water or coating the emitters with herbicides, stop root cell growth at root tips, but due to their environmental severity such herbicides are subject to regulation and can only be used by permit and in specific locations. Irrigation management keeps the areas around emitters wet and it reduces the propensity of fine roots seeking moisture inside the emitters. It does, however, add to the complexity of the irrigation schedule and it increases water consumption without completely eliminating the problem.

The present invention is intended to solve the problem of root intrusion into surface drip irrigation systems without the use of chemical additives or the need for emitter redesign. Currently commercially available grades of Tyvek® plexifilamentary nonwoven web have been disclosed for use in sub surface irrigation systems. (For example U.S. 20150016888.) The present invention broadens the scope of materials available to overcome root intrusion problems in this application.

### SUMMARY OF THE INVENTION

The present invention is based on porous irrigation materials that have the majority of their void space below approximately 35 micrometers and their interstices between their void spaces are connected, continuous structures. The interstices may also comprise fibrous or fibrillated structures.

In a first embodiment, the invention is directed to a method for protecting a region of a subsurface irrigation tube from root or microbial mass intrusion. The method comprises the step of providing a porous cover over the region, wherein the surface cover essentially covers the region of the tube surface, and wherein said cover comprises a non-plexifilamentary material that can be characterized by a peak void volume. The peak void volume is less than 35 microns, and any planar region of the material of an area of 500 square microns or less contains a contiguous polymer structure that remains contiguous when exposed to aqueous fluid.

In a further embodiment the invention is directed to a method for protecting a region of a subsurface irrigation tube from root or microbial mass intrusion, comprising the step of providing a porous cover over the region. The surface cover essentially covers the region of the tube surface, and the cover comprises a material made by the process described in U.S. Pat. No. 7,744,989 and that can be characterized by a peak void volume. The peak void volume is less than 35 microns, and any planar region of the material of an area of 500 square microns or less contains a contiguous polymer structure that remains contiguous when exposed to aqueous fluid.

In a still further embodiment, the material made by the process described in U.S. Pat. No. 7,744,989 can be stretched according to the process described in U.S. application Ser. No. 13/469,431.

### BRIEF DESCRIPTION OF THE FIGURES

FIG. 1 shows a plot of the results of porosimetry measurements on various porous materials used in the invention and comparative examples.

FIG. 2 shows a scanning electron micrograph (SEM) of the surface of a certain plexifilamentary tube used in the invention.

FIG. 3 shows a scanning electron micrograph (SEM) of the surface of an experimental nonwoven tube NW1 used in the invention.

FIG. 4 shows scanning electron micrographs (SEM) of the surface of a certain SMS tube used in the invention.

FIG. 5 is a photograph showing root intrusion into an SMS tube similar to that seen in FIG. 4.

FIG. 6 is a scanning electron micrograph (SEM) of a root intruding into an SMS tube.

FIG. 7 is a photograph showing lack of root intrusion into a plexifilamentary tube.

FIG. 8 is a photograph showing root intrusion into a paper that covers a plexifilamentary tube, with no intrusion into the plexifilamentary tube.

FIG. 9 is a further photograph showing the lack of penetration of roots into a plexifilamentary tube.

FIG. 10 shows a scanning electron micrograph of a cross section of a paper layer being penetrated by a root.

### DETAILED DESCRIPTION OF THE INVENTION

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

By “consists essentially of” is meant that if Item A consists essentially of Item B, the further items may be added to item A that do not affect the operation of A.

The term “polymer” as used herein, generally includes but is not limited to, homopolymers, copolymers (such as for example, block, graft, random and alternating copolymers), terpolymers, etc., and blends and modifications thereof. Furthermore, unless otherwise specifically limited, the term “polymer” shall include all possible geometrical configurations of the material. These configurations include, but are not limited to isotactic, syndiotactic, and random symmetries.

The term “polyolefin” as used herein, is intended to mean any of a series of largely saturated polymeric hydrocarbons composed only of carbon and hydrogen. Typical polyolefins include, but are not limited to, polyethylene, polypropylene, polymethylpentene, and various combinations of the monomers ethylene, propylene, and methylpentene.

The term “polyethylene” as used herein is intended to encompass not only homopolymers of ethylene, but also copolymers wherein at least 85% of the recurring units are ethylene units such as copolymers of ethylene and alpha-olefins. Preferred polyethylenes include low-density polyethylene, linear low-density polyethylene, and high-density polyethylene. A preferred high-density polyethylene has an upper limit melting range of about 130° C. to 140° C., a density in the range of about 0.941 to 0.980 gram per cubic centimeter, and a melt index (as defined by ASTM D-1238-57T Condition E) of between 0.1 and 100, and preferably less than 4.

The term “polypropylene” as used herein is intended to embrace not only homopolymers of propylene but also copolymers where at least 85% of the recurring units are propylene units. Preferred polypropylene polymers include isotactic polypropylene and syndiotactic polypropylene.

The term “plexifilament” as used herein means a three-dimensional integral network or web of a multitude of thin, ribbon-like, film-fibril elements of random length. Typically, these have a mean film thickness of less than about 4 micrometers and a median fibril width of less than about 25 micrometers. The average film-fibril cross sectional area if mathematically converted to a circular area would yield an effective diameter between about 1 micrometer and 25 micrometers. In plexifilamentary structures, the film-fibril elements intermittently unite and separate at irregular intervals in various places throughout the length, width and thickness of the structure to form a continuous three-dimensional network. Examples of plexifilamentary webs are those produced by the flash spinning processes described in U.S. Pat. No. 3,081,519 (Blades et al.), U.S. Pat. No. 3,169,899 (Steuber), U.S. Pat. No. 3,227,784 (Blades et al.), U.S. Pat. No. 3,851,023 (Brethauer et al.), the contents of which are hereby incorporated by reference in their entirety. Examples of commercially available plexifilamentary webs are the sheets supplied by the DuPont Company of Wilmington, Del. under the name Tyvek®.

By “non-plexifilamentary” is meant a material that is not produced by the flash spinning process but still may have a fibrous, and optionally consolidated, structure.

The term “nonwoven” means a web including a multitude of randomly distributed fibers. The fibers generally can be bonded to each other or can be unbonded. The fibers can be staple fibers or continuous fibers. The fibers can comprise a single material or a multitude of materials, either as a combination of different fibers or as a combination of similar fibers each comprised of different materials.

The present invention is directed to a method for protecting a region of a subsurface irrigation tube from root or microbial mass intrusion. The method comprises the step of providing a porous cover over the region, wherein the surface cover essentially covers the region of the tube surface, and wherein said cover comprises a non-plexifilamentary material that can be characterized by a peak void volume. The peak void volume is less than 35 microns, and any planar region of the material of an area of 500 square microns or less contains a contiguous polymer structure that remains contiguous when exposed to aqueous fluid.

In a further embodiment of the invention any planar region of the material of an area of 300 square microns or less may contain a contiguous polymer structure that remains contiguous when exposed to aqueous fluid. In a still further embodiment any planar region of the material of an area of 100 square microns or less may contain a contiguous polymer structure that remains contiguous when exposed to aqueous fluid.

In a still further embodiment any planar region of the material of an area of 50 square microns or less may contain a contiguous polymer structure that remains contiguous when exposed to aqueous fluid.

The material may comprise fibers and the contiguous polymer structure may be formed of a plurality of consolidated fibers. The contiguous polymer structure may also be a microporous film. The contiguous polymer structure may also comprise an SMS nonwoven web.

The tube may consist essentially of the material or be largely constructed of the material.

If the surface layer comprises consolidated fibers, then the consolidated fibers are consolidated into a three dimensional network wherein any given fiber is bonded to at least two other fibers.

The consolidated fibers may have been consolidated by a means selected from the group consisting of thermal bonding, solvent bonding, adhesive bonding and any combination of the foregoing.

The cover may be in the form of a patch.

In a further embodiment the invention is directed to a method for protecting a region of a subsurface irrigation tube from root or microbial mass intrusion, comprising the step of providing a porous cover over the region. The surface cover essentially covers the region of the tube surface, and the cover comprises a material made by the process described in U.S. Pat. No. 7,744,989 and that can be characterized by a peak void volume. The peak void volume is less than 35 microns, and any planar region of the material of an area of 500 square microns or less contains a contiguous polymer structure that remains contiguous when exposed to aqueous fluid.

In a still further embodiment, the material made by the process described in U.S. Pat. No. 7,744,989 can be stretched according to the process described in U.S. application Ser. No. 13/469,431.

The material of the present invention may be a nonwoven, for example an SMS nonwoven web. The nonwoven can be consolidated by processes known in the art (e.g. calendering) in order to impart the desired improvements in physical properties. The term “consolidated” generally means that the material, in particular a nonwoven, has been through a process in which it is compressed and its overall porosity has been reduced. In one embodiment of the invention the as-spun nonwoven is fed into the nip between two unpatterned rolls in which one roll is an unpatterned soft roll and one roll is an unpatterned hard roll. The temperature of one or both rolls, the composition and hardness of the rolls, and the pressure applied to the nonwoven can be varied to yield the desire end use properties. In one embodiment of the invention, one roll is a hard metal, such as stainless steel, and the other a soft-metal or polymer-coated roll or a composite roll having a hardness less than Rockwell B 70. The residence time of the web in the nip between the two rolls is controlled by the line speed of the web, preferably between about 1 m/min and about 50 m/min, and the footprint between the two rolls is the machine direction (MD) distance that the web travels in contact with both rolls simultaneously. The footprint is controlled by the pressure exerted at the nip between the two rolls and is measured generally in force per linear cross-direction (CD) dimension of roll, and is preferably between about 1 mm and about 30 mm.

Further, the material can be stretched, optionally while being heated to a temperature that is between the glass-transition temperature (T_{g}) and the lowest onset-of-melting temperature (Tₒₘ) of the fiber polymer. The stretching can take place either before and/or after the web passes through the calender roll nip, and in either or both of the MD or CD.

The term “continuous” when applied to fibers means that the fibers have been laid down during the manufacture of a nonwoven structure in one continuous stream, as opposed to being broken or chopped.

The term “contiguous structure” in a region means that any point on the structure in the region can be reached from any other point by an object that is not required to leaving the surface of the structure.

By “void volume” is meant the result of a measurement using mercury porosimetry as described below.

By “patch” is meant that the cover may be placed over a region of a tube surface that is less than the entire tube surface and that would otherwise be susceptible to root intrusion in the absence of the patch of material.

“Meltblown fibers” are fibers formed by extruding a molten thermoplastic material through a plurality of fine, usually circular, die capillaries as molten threads or filaments into converging, usually hot and high velocity, gas, e.g. air, streams to attenuate the filaments of molten thermoplastic material and form fibers. During the meltblowing process, the diameter of the molten filaments is reduced by the drawing air to a desired size. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Buntin et al., U.S. Pat. No. 4,526,733 to Lau, and U.S. Pat. No. 5,160,746 to Dodge, II et al., all of which are hereby incorporated herein by this reference. Meltblown fibers may be continuous or discontinuous.

As used herein the term “ spunbond fibers” refers to small diameter fibers which are formed by extruding molten thermoplastic material as filaments from a plurality of fine, usually circular capillaries of a spinnerette with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. Nos. 3,502,763, and U.S. Pat. No. 3,542,615 to Dobo et al. Spunbond fibers are generally continuous and larger than 7 microns, more particularly, they are usually between about 15 and 50 microns.

Spunbond and meltblown fibers can be laminated together, for example into spunbond-meltblown-spunbond structures, designated here as “SMS.” The SMS structures can also be calendered.

By “consolidated fibers” is meant a collection of fibers, some of which that are bonded to each other by some means that can include thermal bonding, adhesive bonding or solvent bonding. A collection of continuous fibers can form a contiguous structure.

By “microporous film” is meant an essentially two dimensional structure that has a thickness much less than its other dimensions, preferably between 0.1 mm and 2 mm, and through the thickness of which are pores that are generally of the order of micron or sub-micron dimensions. Examples would be an expanded polytetrafluoroethylene film (ePTFE) or a microporous film formed from a filled polyolefin.

An ePTFE membrane can be prepared by a number of different known processes, but is preferably prepared by expanding polytetrafluoroethylene as described in U.S. Pat. Nos. 4,187,390; 4,110,239; and 3,953,566 to obtain ePTFE, all of which are incorporated herein by reference. By “porous” is meant that the membrane has an air permeability of at least 0.05 cubic meters per minute per square meter (m/min) at 20 mm water gauge. Membranes with air permeabilities of 200 m/min at 20 mm water or more can be used. The pores are micropores formed between the nodes and fibrils of the ePTFE.

Similarly a membrane can be used that is described in any of U.S. Pat. Nos. 5,234,751, 5,217,666, 5,098,625, 5,225,131, 5,167,890, 4,104,394, 5,234,739, 4,596,837, JPA 1078823 and JPA 3-221541 in which extruded or shaped PTFE which is unexpanded is heated to sinter or semi-sinter the article. This sintered or semi-sintered article is then stretched to form a desired porosity and desired properties.

For special applications, PTFE can be provided with a filler material in order to modify the properties of PTFE for special applications. For example, it is known from U.S. Pat. No. 4,949,284 that a ceramic filter (SiO₂) and a limited amount of microglass fibers can be incorporated in a PTFE material; and in EP-B-0-463106, titanium dioxide, glass fibers, carbon black, activated carbon and the like are mentioned as filler.

In a further non limiting example, techniques for the preparation of microporous films from highly filled polymers, usually polyolefins, are known. Such webs are also suitable for use as the membrane of the invention. Typically a combination of a polyolefin, usually a polyethylene, is compounded with a filler, usually CaCO₃, and extruded and stretched into a film to form a microporous film.

Suitable examples of microporous films for use as the filtration membrane of the present invention include those described in U.S. Pat. Nos. 4,472,328, 4,350,655 and 4,777,073 all of which are incorporated herein by reference.

### EXAMPLES

Hydrostatic head pressure (Hydrohead or HH) measurements on web samples were run on a Textest Instruments FX3000 Hydrotester per method AATC TM 127. Hydrohead was recorded at the first and third water drop penetration and is reported in centimeters of water column (cmwc) as the pressure at the third water drop penetration.

Gurley Hill Porosity is a measure of the barrier of the sheet material for gases. In particular, it is a measure of how long it takes for a volume of gas to pass through an area of material wherein a certain pressure gradient exists. Gurley-Hill porosity is measured in accordance with TAPPI T-460 om-88 using a Lorentzen & Wettre Model 121D Densometer. This test measures the time of which 100 cubic centimeters of air is pushed through a 2.54 cm diameter sample under a pressure of approximately 12.45 cm of water. The result is expressed in seconds and is usually referred to as Gurley Seconds.

Frazier air permeability is a measure of air permeability of porous materials and it was measured according to ASTM D737. In this measurement, a pressure difference of 124.5 N/m² (0.5 inches of water column) is applied to a suitably clamped fabric sample and the resultant air flow rate is measured and reported in units of ft³/ft²/min using a Sherman W. Frazier Co. dual manometer with calibrated orifice.

Void volume was measured by mercury porosimetry. This technique involves the intrusion of mercury at high pressure into a material through the use of a porosimeter. The pore size was determined based on the external pressure needed to force the liquid into a pore against the opposing force of the liquid's surface tension.

The force balance equation known as Washburn's equation for the above material having cylindrical pores is given as:^{[1]}

D=−4Ω Cos β/P

where

P=Applied Pressure, PSIA

Ω=Surface Tension, 485 dyne/cm

β=Contact Angle, 130°

D=Diameter of Pore, μm

The contact angle of mercury with most solids is between 135° and 142°. The surface tension of mercury at 20° C. under vacuum is 480 mN/m. With the various substitutions, the equation becomes:

D=180.457/P (60,000 PSI˜30 Å)

Cylindrical Pore Model
dV=n(πD²/4)L
dA=n(πD)L
dA=(4/D)dV

As pressure increases, so does the cumulative pore volume. From the cumulative pore volume, one can find the pressure and pore diameter where 50% of the total volume has been added to give the median pore diameter.

Plexifilamentary webs of Tyvek® were obtained from DuPont, Wilmington, Del. and were variously prepared by the processes described in U.S. Pat. No. 3,081,519 (Blades et al.), U.S. Pat. No. 3,169,899 (Steuber), U.S. Pat. No. 3,227,784 (Blades et al.), U.S. Pat. No. 3,851,023 (Brethauer et al.).

An experimental nonwoven made by the process of U.S. Pat. No. 7,744,989 and stretched according to the process of U.S. application Ser. No. 13/469,431, SMS and paper were studied to determine the factors that allow roots to intrude into small void spaces where they are naturally attracted due to moisture content. The following were field-tested side by side; Tyvek® irrigation tubes (i.e., 1073B, 1073B/1055B with one side 1073B the other 1055B, and the experimental structure as described in U.S. Pat. No. 7,744,989 and referred to here as NW1), SMS, and a newsprint paper that was attached and covered completely one of the 1073B sides of the Tyvek® irrigation tube. Figures and Tables that show the void space distribution of the materials used.

The following properties were measured on samples. Sample 5 in table 1 was an SMS sample obtained from Midwest Filtration Co., (Cincinnati, Ohio) Samples 1, 2, and 4 were of Tyvek® plexifilamentary web (Du Pont, Wilmington, Del.).

TABLE 1

| | | | | Gurley Hill | |
|---|---|---|---|---|---|
| Tube | | BW | HH* | Porosity** | Frazier*** |
| Material | Type | (oz/yd²) | (cmwc) | (sec/100 cc) | (CFM/ft²) |
| 1 | Tyvek ® | 2.20 | 150 | 22 | N/A |
| | 1073B | | | | |
| 2 | Tyvek ® | 1.80 | 290 | 1200 | N/A |
| | 1055B | | | | |
| 3 | NW1 | 1.5 | 100 | N/A | 0.6 |
| 4 | Tyvek ® | 2.20/1.80 | 150/290 | 22/1200 | N/A |
| | 1073B/1055B | | | | |
| 5 | SMS | 2.75 | 60 | N/A | 30 |

*HH is the water pressure above which water will penetrate through Tyvek ®
**Time (sec) that takes 100 cc of air to penetrate through 1 in² of Tyvek ® under a pressure of 12.45 cm of water
***Frazier measures air flow in ft³/ft²/min under a pressure of 0.5 in of water NW1 is material prepared according to U.S. Pat. No. 7,744,989.

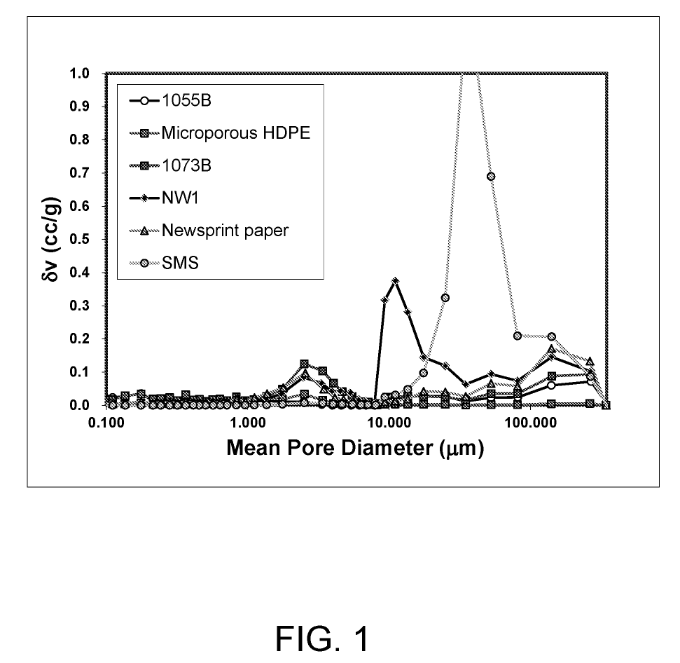

Plexifilamentary, NW1, and SMS irrigation tubes were constructed and field tested with corn. All types were installed side-by-side in the field and they had surface voids accessible to plant roots. Void space distribution of the samples before exposure to roots is shown in table 2 plotted in FIG. 1. In one example, a tube of material 1 was also tested covered with newsprint paper.

TABLE 2

| DESIGNATION | 2 | 1 | 3 | Newsprint | 5 |
|---|---|---|---|---|---|
| % Pore Volume of | 28.2 | 51.1 | 19.0 | 39.7 | 1.2 |
| Interval 0.5 to 9.5 μm | | | | | |
| % Pore Volume of | 25.5 | 14.8 | 58.4 | 13.1 | 17.6 |
| Interval 9.5 to 34.7 μm | | | | | |
| Total % Pore Volume of | 53.6 | 65.9 | 77.4 | 52.8 | 18.9 |
| Interval 0.5 to 34.7 μm | | | | | |
| % Pore Volume of | 46.4 | 34.1 | 22.6 | 47.2 | 81.1 |
| Interval 34.7 to | | | | | |
| 348.4 μm | | | | | |

The majority of Tyvek® 1055B and 1073B interfilamentary void spaces range between 0.5 to 34.7 micrometers. The majority of void spaces for SMS (approximately 81%) were measured to be between 34.7-348.4 micrometers, while only 23-47% was measured for Tyvek® 1055B, 1073B, NW1, and paper for the same range. Void sizes for Tyvek®, SMS and paper were measured to be as large as 348.4 micrometers and they are still smaller than typical SDI emitters.

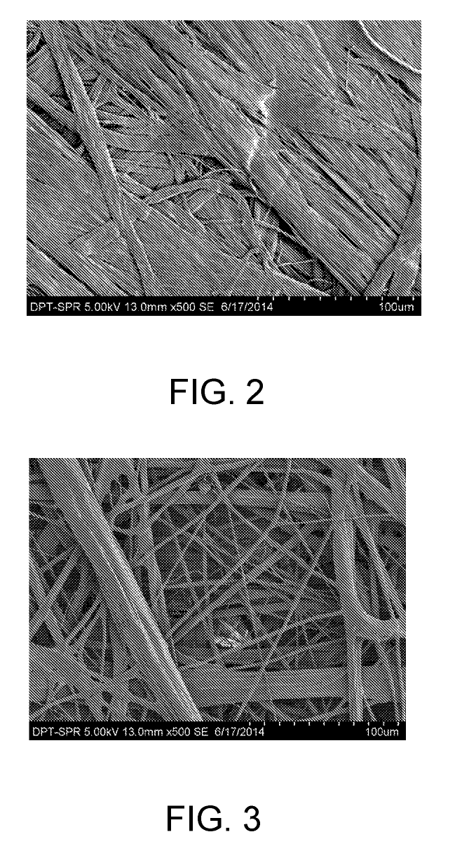

Scanning electron micrographs (SEM) of the samples before root exposure are shown in FIGS. 2-4.

FIG. 2 shows a scanning electron micrograph (SEM) of the surface of tube material 2, a plexifilamentary web used in the invention. FIG. 3 shows a scanning electron micrograph (SEM) of the surface of a tube material 3, an experimental nonwoven material NW1 used in the invention. These figures show the extent to which fibers are consolidated in these structures on a distance scale of around 10 microns, or an area scale of 100 square microns.

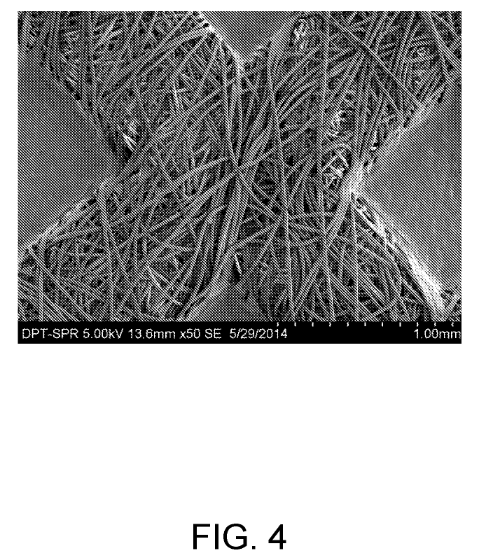

FIG. 4 shows scanning electron micrographs (SEM) of the surface of tube material 5, an SMS web used in the invention. In FIG. 4, fibers are unconsolidated on the 10 micron distance scale, but complete fusing of the fibers occurs at the “diamond” shaped points where bonding is taking place. It is therefore possible on the 100 square micron area scale to find entirely unconsolidated fibers.

Irrigation tubes made of various porous materials were tested in two separate field tests

### Field Test 1

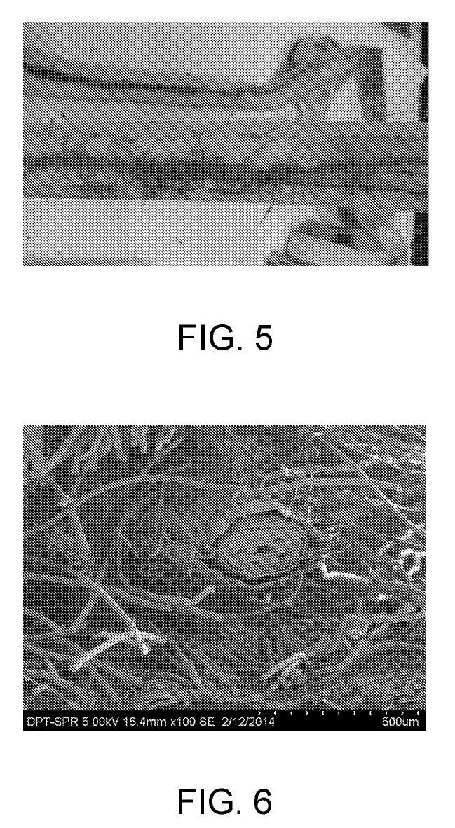

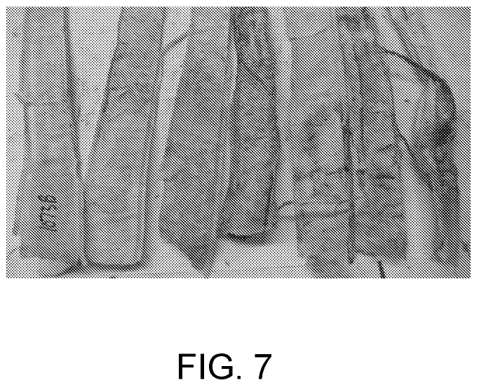

Irrigation tubes based on various materials and lengths were installed in a sandy field in parallel rows approximately 76 cm apart between rows of corn. The tubes were buried approximately 25 cm below the surface of the sandy soil and were filled with water at various applied pressures. Segments of various tube types and lengths were installed side by side in the field. Table 3 shows the types of tubes used, their applied pressure and tube segment lengths. The tubes irrigated the field for one planting season and remained in the ground for approximately 15 months before they were excavated for observations and analysis. FIGS. 5, 6 and 7 show the effect of root exposure in various tube samples that were excavated from the field. FIGS. 5 and 6 show that SMS tubes suffered significant damage due to root intrusion. FIG. 5 shows how extensive was the root intrusion along the SMS tube. FIG. 6 is a scanning electron micrograph of a cross section of a SMS tube that shows a root intruding through the walls of the tube. FIG. 7 shows that the plexifilamentary web did not suffer such intrusion. Even in the case where a plexifilamentary tube segment was folded in the ground and roots were enclosed in the fold no root intrusion or any other damage was observed.

TABLE 3
Field Test 1

| | | Applied | | |
|---|---|---|---|---|
| Tube | | Pressure | Tube | Segment |
| Material | HH (cmwc) | (cmwc) | Segments | Length (m) |
| 1 | 150 | 190 | 6 | 168 |
| 1 | 150 | 160 | 4 | 107 |
| 1 | 150 | 150 | 4 | 107 |
| ½ | 150/290 | 150 | 6 | 107 |
| 5 | 60 | 90 | 4 | 171 |
| 1 | 150 | 160 | 6 | 165 |
| 3 | 100 | 140 | 3 | 159 |
| 1 | 150 | 140 | 1 | 61 |
| 5 | 60 | 130 | 3 | 149 |

### Field Test 2

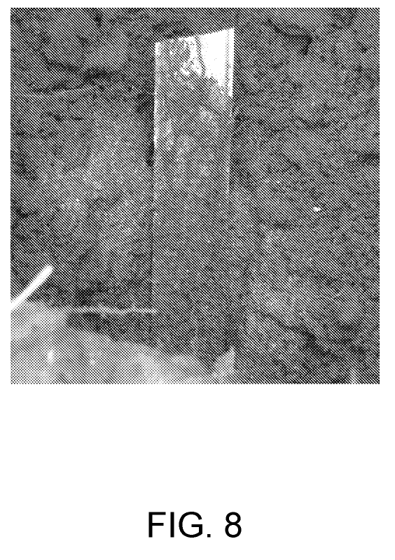

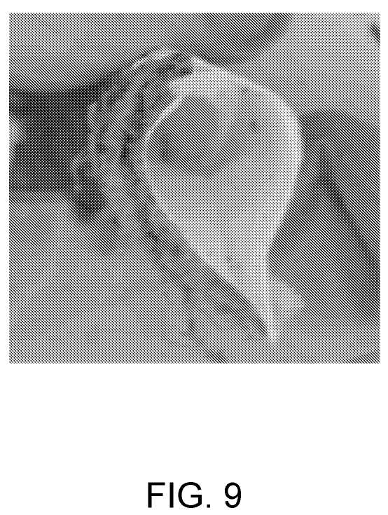

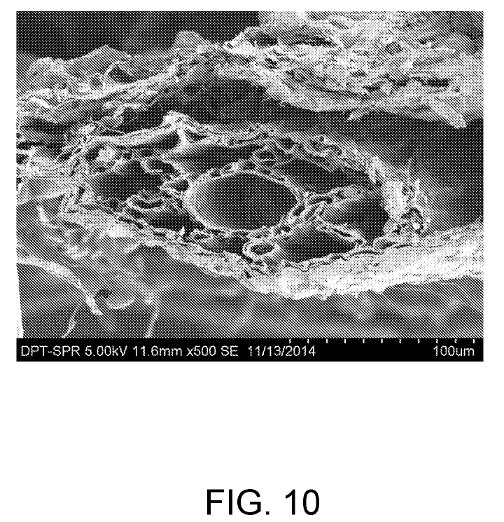

In this field test we used tubes of plexifilamentary material 1 with a paper layer covering one side of the tube. The two plexifilamentary web layers and the paper on top were all welded together ultrasonically. The tubes were installed in a loamy sand field in parallel rows approximately 76 cm apart between rows of corn. The tubes were buried approximately 38 cm below the surface of the loamy sand soil and were filled with water at approximately 160 cmwc of applied pressure. The tubes irrigated the field for one planting season and remained in the ground for approximately 4 months before they were excavated for observations and analysis. Root penetration was observed through the paper but not through the plexifilamentary web in contact with the paper as shown in the photographs in FIGS. 8 and 9. FIG. 10 shows a scanning electron micrograph of a cross section of a paper layer being penetrated by a root.

Contrary to Tyvek® plexifilamentary structures, SMS tubes made of hydrophobic olefinic polymer, suffer root penetration through their fibrous layers. SMS consists of strong thermally bonded consolidated areas and unconsolidated fibers. More than 80% of their void spaces were measured to be between 34.7 and 348.4 micrometers. Roots intrude through the unconsolidated areas of the spunbonded layer in contact with the soil and they may follow a path parallel to the meltblown layer, or they may penetrate through all three layers to the inner side of the tube.

In another case, NW1 which has a much more open structure with total void space volume more than twice that of 1055B and 1073B did not undergo root intrusion. On the contrary, newsprint paper which was attached and covered one side of a Tyvek® 1073B irrigation tube did suffer root intrusion, but none of the Tyvek® sides, neither the side in contact with the paper nor the other. The majority of paper void space is similar to the plexifilamentary web in being between 0.5 to 34.7 micrometers but the paper is hydrophilic and when wet it loses its consolidated, contiguous structure roots can penetrate.

1. An aqueous fluid irrigation system for protecting a region of a subsurface irrigation tube from root or microbial mass intrusion, comprising a porous cover covering a subsurface irrigation tube, wherein the cover essentially covers the region of the tube surface, and wherein the cover comprises a non-plexifilamentary material characterized by a peak void volume of less than 35 microns, and any planar region of the non-plexifilamentary material of an area of 500 square microns or less contains a contiguous polymer structure that remains contiguous when exposed to aqueous fluid.

2. The irrigation system of claim 1 in which any planar region of the material of an area of 300 square microns or less contains a contiguous polymer structure that remains contiguous when exposed to aqueous fluid.

3. The irrigation system of claim 1 in which any planar region of the material of an area of 100 square microns or less contains a contiguous polymer structure that remains contiguous when exposed to aqueous fluid.

4. The irrigation system of claim 1 in which any planar region of the material of an area of 50 square microns or less contains a contiguous polymer structure that remains contiguous when exposed to aqueous fluid.

6.-13. (canceled).

14. The irrigation system of claim 1 in which the contiguous polymer structure is a microporous film.

15. The irrigation system of claim 1 in which the tube consists essentially of the non-plexifilamentary material.

16. The irrigation system of claim 1 in which the non-plexifilamentary material comprises fibers and the contiguous polymer structure is formed of a plurality of consolidated fibers.

17. The irrigation system of claim 16 in which said consolidated fibers are consolidated into a three-dimensional network material wherein any given fiber is bonded to at least two other fibers.

18. The irrigation system of claim 17 in which the material has an SMS structure.

19. The irrigation system of claim 16 in which the consolidated fibers have been consolidated by a means selected from the group consisting of thermal bonding, solvent bonding, adhesive bonding and any combination of the foregoing.

20. The irrigation system of claim 1 in which the cover is in the form of a patch.

21. A method for protecting a region of a subsurface irrigation tube from root or microbial mass intrusion, comprising the step of providing a porous cover over the region, wherein the surface cover essentially covers the region of the tube surface, and wherein said cover comprises a material and that can be characterized by a peak void volume, and wherein the peak void volume is less than 35 microns, and any planar region of the material of an area of 500 square microns or less contains a contiguous polymer structure that remains contiguous when exposed to aqueous fluid.
